(19) United States
(12) Patent Application Publication
(10) Pub. No.: US 2021/0133595 A1
(43) Pub. Date: May 6, 2021

(54) METHOD FOR DESCRIBING PREDICTION MODEL, NON-TRANSITORY COMPUTER-READABLE STORAGE MEDIUM FOR STORING PREDICTION MODEL DESCRIPTION PROGRAM, AND PREDICTION MODEL DESCRIPTION DEVICE

(71) Applicant: FUJITSU LIMITED, Kawasaki-shi (JP)

(72) Inventors: Shunichi WATANABE, Kawasaki (JP); YUSUKE OKI, Kawasaki (JP)

(73) Assignee: FUJITSU LIMITED, Kawasaki-shi (JP)

(21) Appl. No.: 17/079,687

(22) Filed: Oct. 26, 2020

(30) Foreign Application Priority Data
Oct. 30, 2019 (JP) 2019-196929

(51) Int. Cl. G06N 5/02

(52) U.S. Cl. CPC G06N 5/02

(57) ABSTRACT

A method includes: selecting a plurality of models by using data set and a prediction result of a prediction model for the data set, each model being configured to linearly separate data included in the data set input to the prediction model; creating a decision tree such that a leaf of the decision tree corresponds to each selected model and a node of the decision tree corresponds to each of logics classifying the data from a root to each leaf of the decision tree; specifying a branch to be pruned by using variation in the data belonging to each leaf of the created decision tree; recreating the decision tree by using the data set corresponding to the decision tree in which the specified branch has been pruned; and outputting each of the logics corresponding to each node of the recreated decision tree as a description result of the prediction model.

### CROSS-REFERENCE TO RELATED APPLICATION

This application is based upon and claims the benefit of priority of the prior Japanese Patent Application No. 2019-196929, filed on Oct. 30, 2019, the entire contents of which are incorporated herein by reference.

### FIELD

The embodiments discussed herein are related to a method for describing a prediction model, a non-transitory computer-readable storage medium for storing a prediction model description program, and a prediction model description device.

### BACKGROUND

In the prior art, there are technologies for facilitating interpretation of a prediction result that tends to be a black box, regarding a prediction model generated by machine learning or the like. Regarding the interpretation of such a prediction result, a technology of specifying weights of regression coefficients of a model that is capable of linearly separating from a learning data set, and making description using the specified weights is known.

Examples of the related art include Japanese Laid-open Patent Publication No. 2016-91306, Japanese Laid-open Patent Publication No. 2005-222445, and Japanese Laid-open Patent Publication No. 2009-301557.

### SUMMARY

According to an aspect of the embodiments, provided is a method for describing a prediction model, the method being implemented by a computer. In an example, the method includes: selecting a plurality of models in accordance with data set and a prediction result of a prediction model for the data set, each of the plurality of models being configured to linearly separate data included in the data set input to the prediction model; creating a decision tree such that a leaf of the decision tree corresponds to each of the plurality of selected models and a node of the decision tree corresponds to each of logics that classify the data included in the data set from a root to each leaf of the decision tree; specifying a branch to be pruned of the decision tree in accordance with variation in the data belonging to each leaf of the created decision tree; recreating the decision tree in accordance with the data set corresponding to the decision tree in which the specified branch has been pruned; and outputting each of the logics corresponding to the each node of the recreated decision tree as a description result of the prediction model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary functional configuration of an information processing device according to an embodiment;

FIG. 2 is a flowchart illustrating an operation example of an information processing device according to the embodiment;

FIG. 3 is an explanatory diagram for describing generation and selection of an interpretable model;

FIG. 4 is an explanatory diagram for describing generation of a decision tree;

FIG. 5 is an explanatory diagram for describing pruning of a decision tree;

FIG. 6 is an explanatory diagram for describing a recreated decision tree;

FIG. 7 is an explanatory diagram illustrating an output result;

FIG. 8 is an explanatory diagram for describing a difference in the number of interpretable models; and

FIG. 9 is a block diagram illustrating an example of a computer that executes a prediction model description program.

### DESCRIPTION OF EMBODIMENT(S)

However, the above-described technology has a problem of having a difficulty in obtaining sufficient description performance for the prediction model. For example, the model capable of linear separation gives a reason for one data in the learning data set, and reasons for the other data are unknown. Therefore, a calculation amount increases if simply increasing the number of models capable of linear separation so as to attempt description of the learning data set as a whole using the plurality of models capable of linear separation. Meanwhile, descriptiveness for the prediction model becomes insufficient if decreasing the number of models capable of linear separation.

According to an aspect of the embodiments, provided is a solution to provide a method for describing a prediction model for enabling description of the prediction model with high accuracy, a prediction model description program, and a prediction model description device.

Hereinafter, a method for describing a prediction model, a prediction model description program, and a prediction model description device according to embodiments will be described with reference to the drawings. The configurations with the same functions in the embodiments are denoted by the same reference signs, and the redundant description will be omitted. Note that the method for describing a prediction model, the prediction model description program, and the prediction model description device described in the following embodiments are merely examples and do not limit the embodiments. Furthermore, each embodiment below may be appropriately combined within the scope of no contradiction.

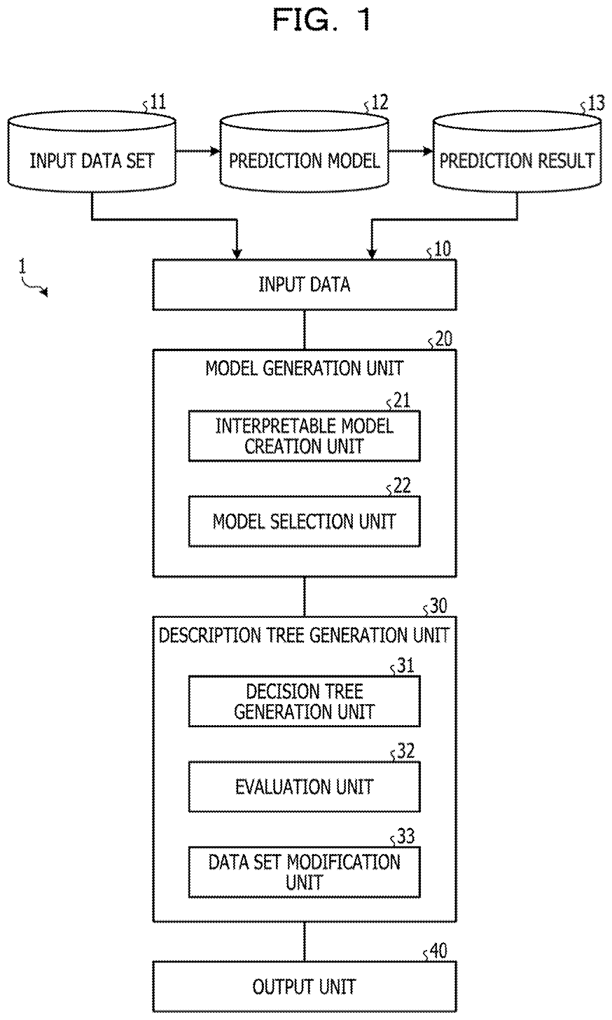

FIG. 1 is a block diagram of an exemplary functional configuration of an information processing device according to an embodiment. As illustrated in FIG. 1, an information processing device 1 receives input of an input data set 11 of data to be input to a prediction model 12 generated by machine learning or the like, and a prediction result 13 predicted by the prediction model 12 on the basis of the input data set 11. Then, the information processing device 1 obtains a logic for the prediction model 12 for predicting (classifying) a label from the data included in the input data set 11, using a decision tree method on the basis of the input data set 11 and the prediction result 13, and outputs the logic as a description result of the prediction model 12. That is, the information processing device 1 is an example of a prediction model description device. As the information processing device 1, a personal computer or the like can be applied, for example.

Specifically, the information processing device 1 selects a plurality of models capable of linearly separating the data included in the input data set 11 on the basis of the prediction result 13 such as the label predicted by the prediction model 12 from the data included in the input data set 11. Note that the model capable of linearly separating data is a straight line (n−1 dimensional hyperplane in an n dimensional space) for separating a set of the labels (for example, a set of Class A and Class B in the case of classifying the labels into Class A and Class B) predicted by the prediction model 12 in a space in which each element (for example, an item of the data) is a dimension. As an example, the model capable of linearly separating data is a multiple regression model close to a separation plane (along a separation plane) of labels.

Such a model capable of linearly separating data can be said to be a model capable of interpreting the prediction model 12 (hereinafter also called interpretable model) because the model can be regarded as an important model for separating the set of labels predicted by the prediction model 12. In the decision tree method, a decision tree having the plurality of selected models capable of linearly separating data as leaves, and having logics for classifying the data included in the input data set 11 from a root to the leaf as a node (intermediate nodes) is generated on the basis of the data included in the input data set 11.

The logic of each intermediate node in this decision tree can be expressed as a conditional expression in a predetermined item. In the generation of the decision tree, the intermediate node is obtained in order from the root by setting a threshold value of the conditional expression so as to divide the data into two for the predetermined item. For example, the information processing device 1 focuses on one item (dimension) in the input data set 11 and sequentially repeats decision of the threshold value (decision of the intermediate node) in the conditional expression for that item so that the set of the input data set 11 is divided into two, thereby generating the decision tree. At this time, the information processing device 1 generates the intermediate node such that data closest to the model capable of linearly separating data belongs to the leaf of the decision tree as much as possible. Among the decision trees generated using the decision tree method, a final decision tree used as the description result of the prediction model 12 may be referred to as a description tree.

Specifically, the information processing device 1 includes an input unit 10, a model generation unit 20, a description tree generation unit 30, and an output unit 40.

The input unit 10 is a processing unit that receives inputs of the input data set 11 and the prediction result 13. The input unit 10 outputs the received input data set 11 and prediction result 13 to the model generation unit 20.

The model generation unit 20 is a processing unit that selects a plurality of interpretable models for the data included in the input data set 11 on the basis of the input data set 11 and the prediction result 13. The model generation unit 20 includes an interpretable model creation unit 21 and a model selection unit 22.

The interpretable model creation unit 21 generates a plurality of straight lines (n−1 dimensional hyperplanes in the case of an n dimensional space) for separating a set of labels indicated by the prediction result 13 of the prediction model 12 in a space where the input data set 11 is plotted, that is, models capable of linearly separating data by multiple regression calculation or the like. The model selection unit 22 selects a plurality of models closer to a separation plane from among the generated models to approximate the separation plane by combining the plurality of models.

The description tree generation unit 30 is a processing unit that generates a description tree (decision tree) to be used as the description result of the prediction model 12. The description tree generation unit 30 includes a decision tree generation unit 31, an evaluation unit 32, and a data set modification unit 33.

The decision tree generation unit 31 generates a decision tree having each of the plurality of models selected by the model selection unit 22 as a leaf and having each of logics for classifying the data included in the input data set 11 from a root to the leaf as a node.

Specifically, the decision tree generation unit 31 defines each of the plurality of models selected by the model selection unit 22 as a leaf of the decision tree. Next, the decision tree generation unit 31 determines a logic (intermediate node) for classifying data in order from the root by setting a threshold value of a conditional expression so as to divide the data into two for a predetermined item of the data included in the input data set 11. At this time, the decision tree generation unit 31 obtains a distance between a point where the data is plotted and the model, and determines content of the logic at the intermediate node such that the data closest to the interpretable model belongs to the leaf of the decision tree as much as possible.

The evaluation unit 32 is a processing unit that evaluates variation in data belonging to the leaves of the decision tree created by the decision tree generation unit 31. In the decision tree generated by the decision tree generation unit 31, the data closest to the interpretable model belongs to each leaf as much as possible, but there are some cases where data closest to another model different from the model of the leaf belongs. Regarding the data belonging to each leaf of the decision tree, the evaluation unit 32 measures an amount of data closest to another model different from the model of the leaf with respect to the number of data closest to the model of the leaf, thereby evaluating the variation in the data.

In the decision tree, the part (leaf) where the data has variation is a part that is difficult to interpret at the time of description of the model by the decision tree method. That is, the data belonging to the leaf having the variation in the data corresponds to data difficult to interpret by the decision tree method. In the present embodiment, such data difficult to interpret is removed from the input data set 11, and a decision tree is recreated, whereby a decision tree having higher reliability (having no part (leaf) difficult to interpret or less parts (leaves) difficult to interpret) is generated.

Specifically, the evaluation unit 32 prunes a branch to the leaf having the variation in the data, and obtains an influence (cost in the case of pruning a branch (modified cost function)) on the decision tree in the case of deleting the data belonging to the leaf. Then, the evaluation unit 32 specifies a branch that minimizes the modified cost function in the case of pruning the branch as the branch to be pruned.

For example, the evaluation unit 32 specifies the branch with the minimum cost (minC) by the modified cost function that is minC=R(T)+αE(T). Here, T is the decision tree, R(T) is an evaluation value for the reliability of the decision tree, E(T) is an evaluation value for a data range of the branch in the decision tree, and a is a regularization parameter (penalty value).

The data set modification unit 33 is a processing unit that modifies the data set for which the decision tree generation unit 31 generates a decision tree. Specifically, the data set modification unit 33 excludes, from the data included in the input data set 11, the data belonging to the leaf of the branch specified as the branch to be pruned by the evaluation unit 32. Thereby, the data set modification unit 33 obtains the data set corresponding to the decision tree obtained by pruning the branch specified by the evaluation unit 32. The decision tree generation unit 31 recreates the decision tree using the data set modified by the data set modification unit 33.

The output unit 40 is a processing unit that outputs each logic corresponding to each node (intermediate node) of the decision tree (description tree) generated by the description tree generation unit 30 as the description result of the prediction model 12. Specifically, the output unit 40 reads the logic (the conditional expression of a predetermined item) of the intermediate node from the root to the leaf of the description tree and outputs the read logic to a display, a file, or the like. Thereby, a user can easily interpret the prediction result 13 by the prediction model 12.

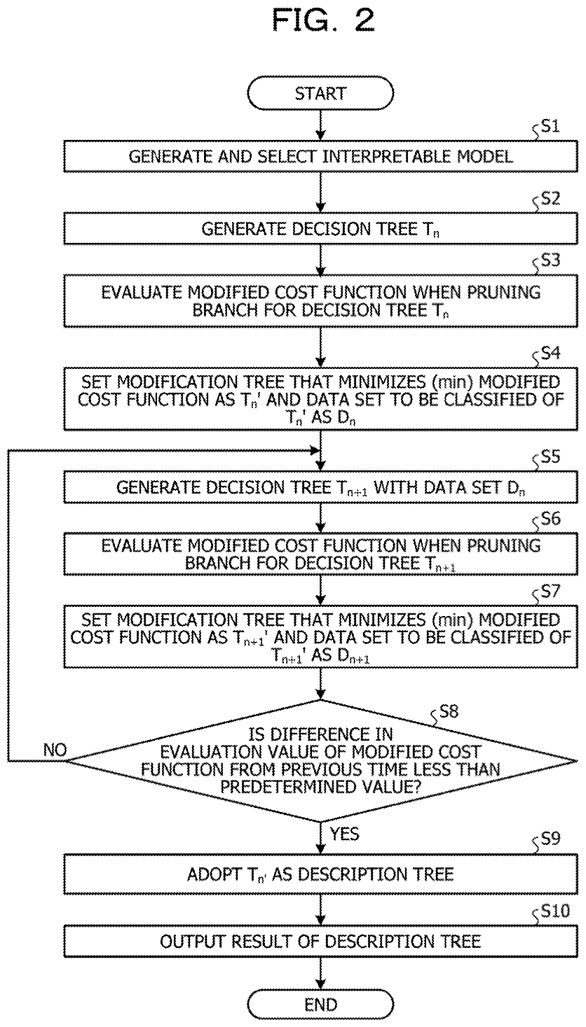

FIG. 2 is a flowchart illustrating an operation example of the information processing device 1 according to the embodiment. As illustrated in FIG. 2, when the processing is started, the model generation unit 20 performs processing of generating a plurality of interpretable models and selecting a plurality of interpretable models close to a separation plane from among the generated interpretable models (S1).

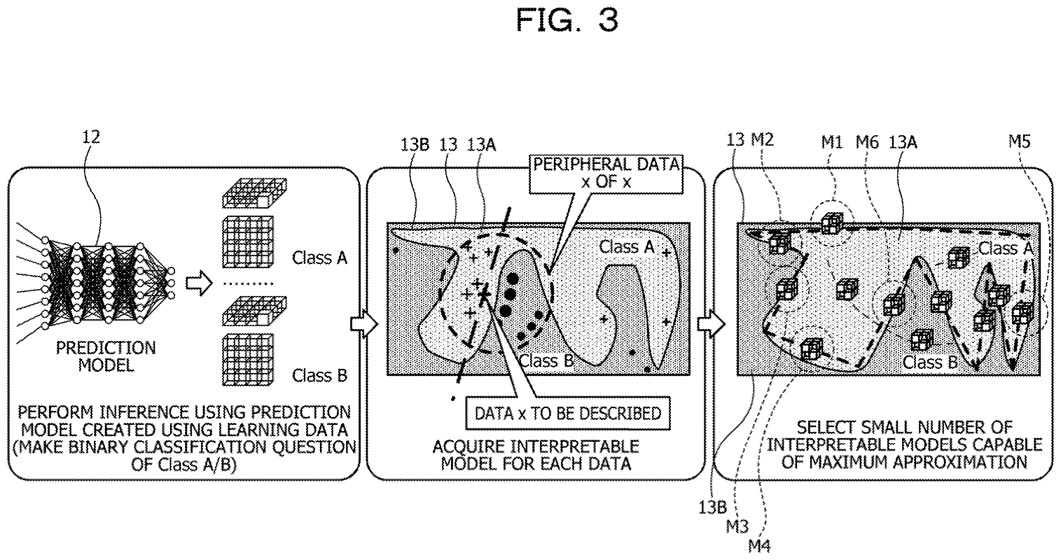

FIG. 3 is an explanatory diagram for describing generation and selection of an interpretable model. As illustrated in FIG. 3, it is assumed that the prediction model 12 is classified into two values: a label 13A of “Class A” and a label 13B of “Class B”.

The interpretable model creation unit 21 obtains a plurality of straight lines (interpretable models) for separating the set of labels 13A and 13B by multiple regression calculation or the like. The model selection unit 22 combines the plurality of obtained interpretable models and selects a small number of interpretable models capable of maximally approximating the separation plane (M1 to M6 in the illustrated example).

Returning to FIG. 2, after S1, the decision tree generation unit 31 generates a decision tree Tₙ having each of the plurality of models (interpretable models M1 to M6) selected by the model selection unit 22 as a leaf and having each of logics for classifying the data included in the input data set 11 from a root to the leaf as a node (S2).

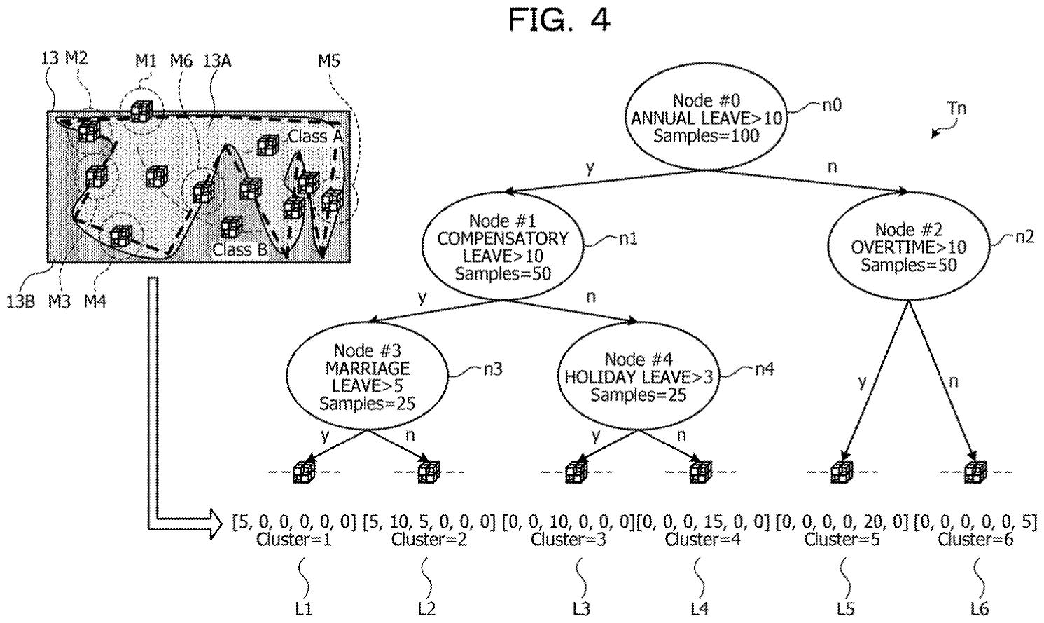

FIG. 4 is an explanatory diagram for describing generation of the decision tree Tₙ. As illustrated in FIG. 4, the decision tree generation unit 31 generates the decision tree Tₙ having the interpretable models M1 to M6 as leaves L1 to L6, respectively, and classifying the data included in the input data set 11 at nodes n0 to n4. Note that the numbers in the parentheses for the leaves L1 to L6 indicate the amount of data closest to the interpretable models M1 to M6 in order from the left. From the amount of data, the leaf L2 has [5, 10, 5, 0, 0, 0], and thus there is variation in the data.

Next, the evaluation unit 32 evaluates the modified cost function (minC=R(T)+αE(T)) at the time of pruning the branch connected to each leaf for the decision tree Tₙ (S3).

For example, the evaluation unit 32 calculates minC=R(T)+αE(T) of each leaf with α=0.1 and E(T)=1−(Dₙ₊₁/Dₙ). Note that Dₙ indicates a data set to be classified in the decision tree Tₙ, and Dₙ₊₁ indicates a data set in a decision tree Tₙ₊₁ in the case where the branch to be pruned has been pruned.

As an example, calculation of the cost (C) at the time of pruning a branch (Node #3_n) connected to the leaf L2 illustrated in FIG. 4 is as follows.

C=(1−15/20)*(20/100)+0.1*(1−(80/100))=0.070

Similarly, calculation of the cost (C) at the time of pruning a branch (Node #4_n) connected to the leaf L4 illustrated in FIG. 4 is as follows.

C=(1−10/20)*(20/100)+0.1*(1−(80/100))=0.120

Next, the evaluation unit 32 specifies the branch that minimizes (min) the modified cost function for the decision tree Tₙ. Next, the data set modification unit 33 sets a modification tree obtained by pruning the specified branch as Tₙ′, and excludes data belonging to the leaf of the branch specified by the data set modification unit 33 from the input data set 11. Then, the data set modification unit 33 sets a data set obtained by excluding the data belonging to the leaf of the branch specified by the data set modification unit 33, that is, a data set that is to be classified of Tₙ′, as Dₙ (S4).

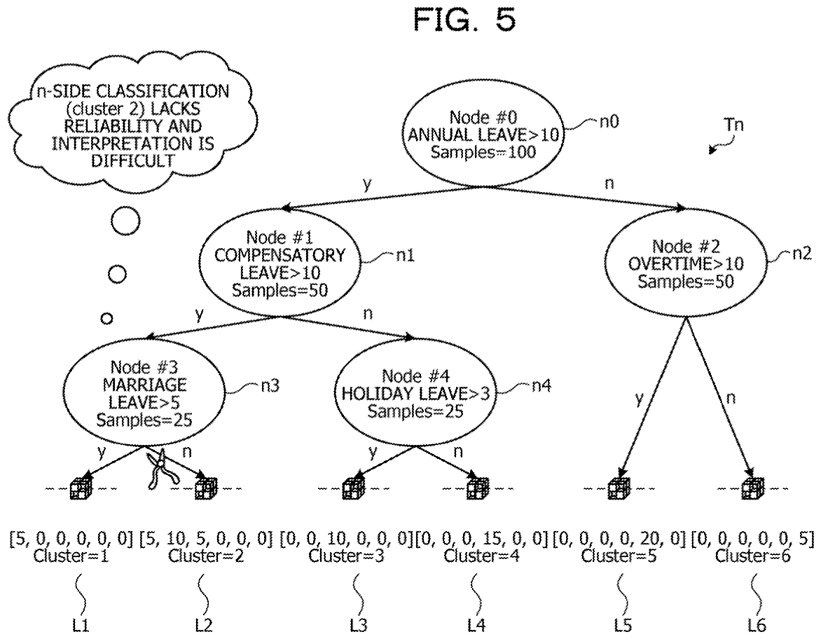

FIG. 5 is an explanatory diagram for describing pruning of the decision tree Tₙ. As illustrated in FIG. 5, the classification (leaf L2) on the n side at the node n3 lacks reliability and is difficult to interpret because the data has variation. Therefore, the data set modification unit 33 prunes the branch connected to the leaf L2 that minimizes the modified cost function (0.07 in the illustrated example) to obtain the data set Dₙ of the modification tree Tₙ′.

Next, the decision tree generation unit 31 generates the decision tree Tₙ₊₁ with the data set Dₙ (S5). Next, the evaluation unit 32 evaluates the modified cost function at the time of pruning the branch connected to each leaf for the decision tree Tₙ₊₁ (S6), similarly to S3.

Next, the evaluation unit 32 specifies the branch that minimizes (min) the modified cost function for the decision tree Tₙ₊₁. Next, the data set modification unit 33 sets a modification tree obtained by pruning the specified branch as Tₙ₊₁′, and excludes data belonging to the leaf of the branch specified by the data set modification unit 33 from the data set Dₙ. Then, the data set modification unit 33 sets a data set obtained by excluding the data belonging to the leaf of the branch specified by the data set modification unit 33, that is, a data set that is to be classified of Tₙ₊₁′, as Dₙ₊₁ (S7).

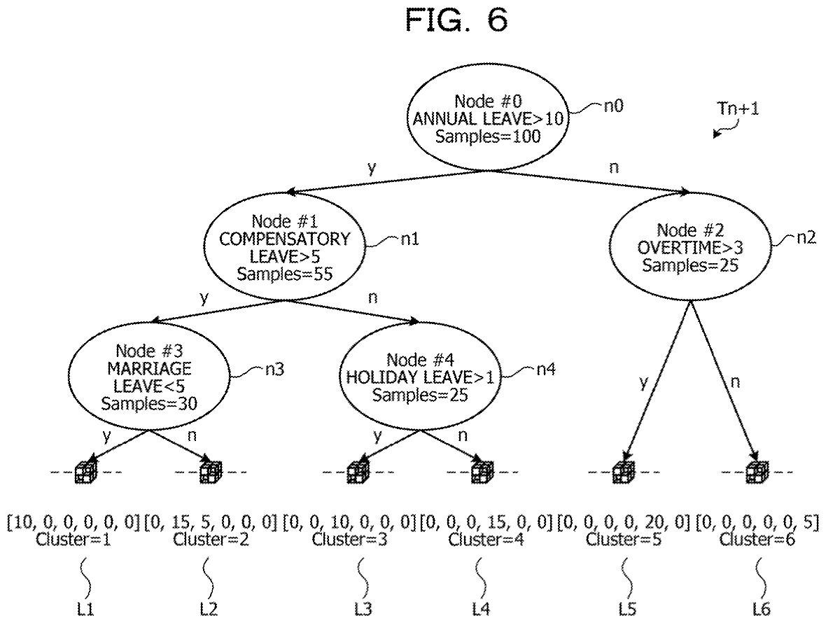

FIG. 6 is an explanatory diagram for describing a recreated decision tree Tₙ₊₁. As illustrated in FIG. 6, the decision tree generation unit 31 generates the decision tree Tₙ₊₁ having the interpretable models M1 to M6 as leaves L1 to L6, respectively, and classifying the data included in the data set Dₙ at nodes n0 to n4. In the decision tree Tₙ₊₁ recreated in this way, the data variation in the leaf L2 is smaller than the previous time because the data amount is [0, 15, 5, 0, 0, 0].

Note that the calculation of the cost (C) at the time of pruning the branch (Node #3_n) connected to the leaf L2 illustrated in FIG. 6 is as follows.

C=0+0.1*(1−(60/80))=0.025

Next, the description tree generation unit 30 determines whether a difference in the evaluation value (C) of the modified cost function in the pruned branch from the previous time is less than a predetermined value (ε) (S8). An arbitrary value can be set as the predetermined value (ε).

In the case where the evaluation value (C) is less than the predetermined value (ε) and the change in the evaluation value of the modified cost function is sufficiently small (S8: Yes), the description tree generation unit 30 adopts the decision tree Tₙ₊₁ generated with the data set Dₙ of the modification tree Tₙ′ as the description tree (S9).

For example, the value (previous value) of the modified cost function in the case of pruning the branch connected to the leaf L2 illustrated in FIG. 5 is 0.070, and the value (current value) of the modified cost function in the case of pruning the branch connected to the leaf L2 illustrated in FIG. 6 is 0.025 Therefore, in the case where 0.070−0.025<ε, the description tree generation unit 30 sets the decision tree Tₙ₊₁ generated in S5 as the description tree.

In the case where the evaluation value (C) is not less than the predetermined value (ε) (S8: No), the description tree generation unit 30 returns the processing to S5 to recreate the decision tree with the data set Dₙ₊₁ in S7. Thereby, pruning a branch is repeated until the change in the cost in the case of pruning a branch becomes sufficiently small.

After S9, the output unit 40 outputs the description tree result generated by the description tree generation unit 30 to a display, a file, or the like (S10).

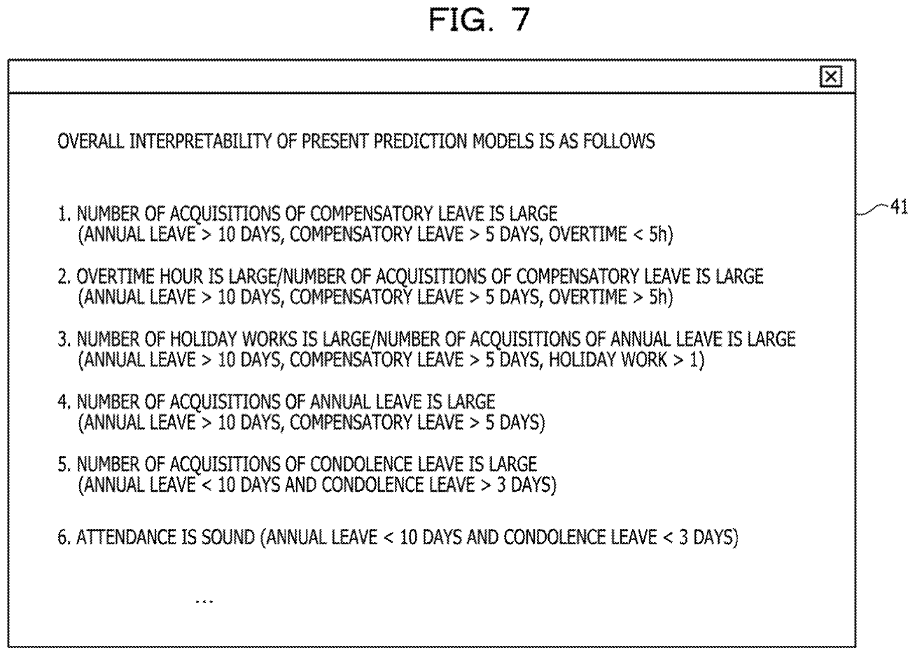

FIG. 7 is an explanatory diagram illustrating an output result. As illustrated in FIG. 7, logics (for example, annual leave >10 days, compensatory leave >5 days, and overtime <5 h) corresponding to the nodes of the description tree generated by the description tree generation unit 30 are listed on an output result screen 41 by the output unit 40. Furthermore, the output unit 40 may output determination results (for example, the number of acquisitions of the compensatory leave is large and the overtime hour is large) as to whether the content of the logics satisfies predetermined conditions (for example, the number of compensatory leaves and the overtime hour are predetermined values or larger) on the output result screen 41. Thereby, the user can easily interpret the prediction result 13 by the prediction model 12.

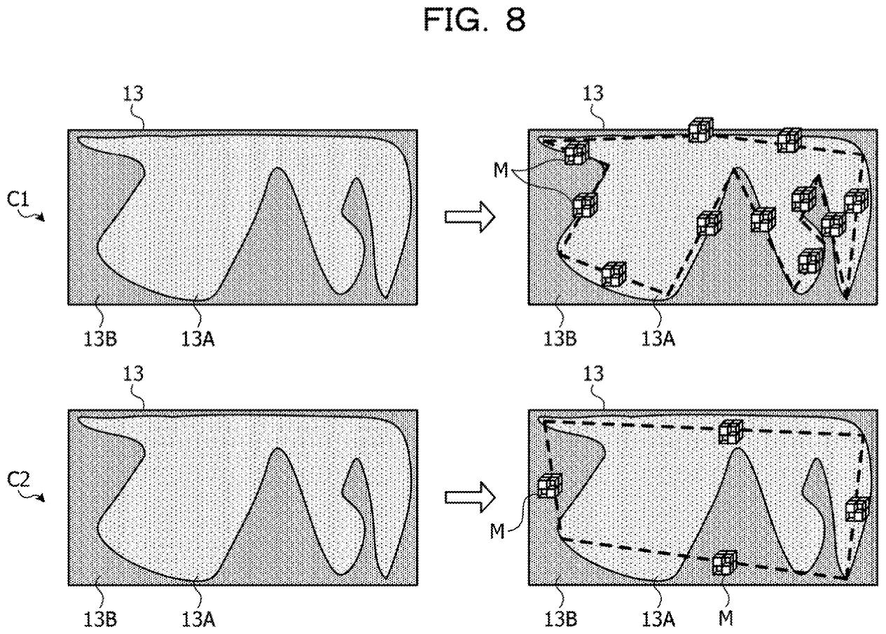

FIG. 8 is an explanatory diagram for describing a difference in the number of interpretable models. As illustrated in case C1 in FIG. 8, in the case where the number of interpretable models M becomes large, the amount of calculation increases according to the number of interpretable models M. Furthermore, as illustrated in case C2, in the case where the number of interpretable models M is small, description of a learning space in the prediction result 13 becomes insufficient. In the present embodiment, by selecting the interpretable model M close to the separation plane of the labels 13A and 13B, sufficient descriptiveness can be obtained at an appropriate calculation cost.

As described above, the information processing device 1 includes the model generation unit 20, the description tree generation unit 30, and the output unit 40. The model generation unit 20 selects the plurality of models capable of linearly separating the data included in the input data set 11 on the basis of the input data set 11 input to the prediction model 12 and the prediction result 13 of the prediction model 12 for the input data set 11. The description tree generation unit 30 creates the decision tree having each of the plurality of selected models as a leaf and having each of the logics for classifying the data included in the input data set 11 from the root to the leaf as a node. Furthermore, the description tree generation unit 30 specifies the branch to be pruned of the decision tree on the basis of the variation of the data belonging to the leaf of the created decision tree. Furthermore, the description tree generation unit 30 recreates the decision tree on the basis of the data set corresponding to the decision tree obtained by pruning the specified branch. The output unit 40 outputs each logic corresponding to each node of the recreated decision tree as the description result of the prediction model 12.

In the description of the prediction model 12 by the decision tree method using the input data set 11, there are some cases where data difficult to interpret is included in the input data set 11, and such data difficult to interpret hinders creation of the decision tree having high reliability. The information processing device 1 outputs, as the description result of the prediction model 12, each of the logics corresponding to the nodes of the decision tree recreated after pruning the branches of the decision tree corresponding to the data difficult to interpret to prune the data. Therefore, the prediction model 12 can be described with high accuracy.

Furthermore, the description tree generation unit 30 calculates the cost of the case of pruning the branch having variation in the data belonging to the leaf of the decision tree, and specifies the branch that minimizes the calculated cost as the branch to be pruned. Thereby, the information processing device 1 can prune the data such that the cost in the case of pruning the data can be minimized, and can reduce the influence on the data other than the data difficult to interpret by pruning.

Furthermore, the description tree generation unit 30 repeats the processing of specifying the branch to be pruned until the difference between the cost calculated for the decision tree recreated this time and the cost calculated for the decision tree recreated previous time becomes less than the predetermined value, and recreating the decision tree obtained by pruning the specified branch. As described above, the information processing device 1 repeats pruning a branch until the change in the cost in the case of pruning the branch becomes sufficiently small, thereby improving the interpretability in the decision tee.

Furthermore, the input data set 11 may be a data set used for generating the prediction model 12 to which the prediction result is given as a correct answer. The model generation unit 20 selects a plurality of models capable of linearly separating data included in the data set on the basis of the data set and the prediction result given to the data set. As described above, the information processing device 1 may obtain the data set used for generating the prediction model 12, that is, the plurality of models capable of linearly separating data from teacher data. Thereby, the information processing device 1 can obtain the description result regarding the prediction model 12 generated from the teacher data.

Furthermore, each of the constituent elements of the units illustrated in the drawings does not necessarily need to be physically configured as illustrated in the drawings. In other words, specific aspects of separation and integration of the respective components are not limited to the illustrated forms, and all or some of the components may be functionally or physically separated and integrated in an arbitrary unit depending on various loads, usage states, and the like. For example, the model generation unit 20 and the description tree generation unit 30 may be integrated. Furthermore, the order of each illustrated processing is not limited to the order described above, and the processing may be concurrently executed or may be executed as changing the order in a range in which the processing content does not contradict.

Moreover, all or some of the various processing functions to be executed by each device may be executed by a CPU (or microcomputer such as MPU or micro controller unit (MCU)). Furthermore, it is needless to say that whole or any part of various processing functions may be executed by a program to be analyzed and executed on a CPU (or a microcomputer, such as an MPU or an MCU), or on hardware by wired logic.

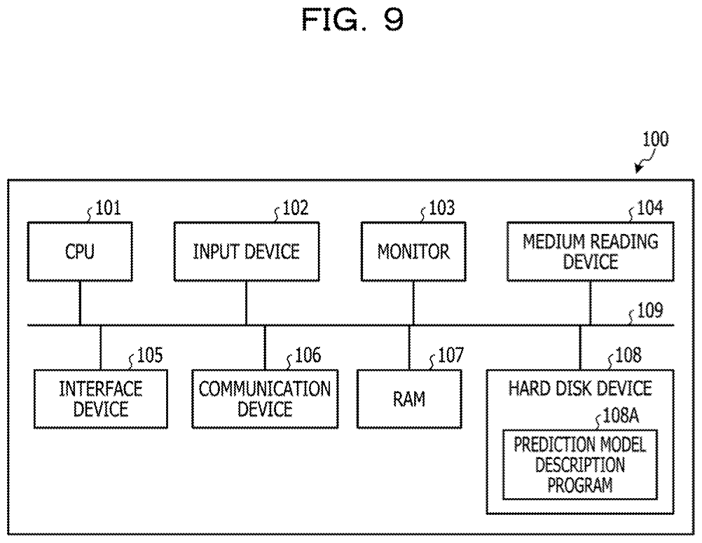

By the way, the various types of processing described in the above-described embodiments can be implemented by execution of a prepared program on a computer. Thus, hereinafter, an example of a computer that executes a prediction model description program having a similar function to the above-described embodiments. FIG. 9 is a block diagram illustrating an example of a computer that executes a prediction model description program.

As illustrated in FIG. 9, a computer 100 includes a CPU 101 that executes various types of calculation processing, an input device 102 that receives data input, and a monitor 103. Furthermore, the computer 100 includes a medium reading device 104 that reads a program and the like from a storage medium, an interface device 105 that connects to various devices, and a communication device 106 that connects other information processing devices and the like in a wired or wireless manner. Furthermore, the computer 100 also includes a random access memory (RAM) 107 that temporarily stores various types of information, and a hard disk device 108. Furthermore, the devices 101 to 108 are connected to a bus 109.

The hard disk device 108 stores a prediction model description program 108A having similar functions to the respective processing units of the input unit 10, the model generation unit 20, the description tree generation unit 30, and the output unit 40 illustrated in FIG. 1. Furthermore, the hard disk device 108 stores various data for implementing the input unit 10, the model generation unit 20, the description tree generation unit 30, and the output unit 40. For example, the input device 102 receives inputs of various types of information such as operation information from a user of the computer 100, for example. The monitor 103 displays various screens such as a display screen for the user of the computer 100, for example. The interface device 105 is connected to, for example, a printing device and the like. The communication device 106 is connected to a network (not illustrated) and exchanges various types of information with other information processing devices.

The CPU 101 reads the prediction model description program 108A stored in the hard disk device 108, loads the prediction model description program 108A on the RAM 107, and executes the prediction model description program 108A, thereby performing various types of processing. Furthermore, these programs can cause the computer 100 to function as the input unit 10, the model generation unit 20, the description tree generation unit 30, and the output unit 40 illustrated in FIG. 1.

Note that the above-described prediction model description program 108A may not be stored in the hard disk device 108. For example, the computer 100 may read and execute the prediction model description program 108A stored in a storage medium readable by the computer 100. The storage medium readable by the computer 100 corresponds to, for example, a portable recording medium such as a compact disk read only memory (CD-ROM), a digital versatile disk (DVD), or a universal serial bus (USB) memory, a semiconductor memory such as a flash memory, a hard disk drive, or the like. Alternatively, the prediction model description program 108A may be prestored in a device connected to a public line, the Internet, a local area network (LAN), or the like, and the computer 100 may read the prediction model description program 108A from the device and execute the prediction model description program 108A.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for describing a prediction model, the method being implemented by a computer, the method comprising:
selecting a plurality of models in accordance with data set and a prediction result of a prediction model for the data set, each of the plurality of models being configured to linearly separate data included in the data set input to the prediction model;
creating a decision tree such that a leaf of the decision tree corresponds to each of the plurality of selected models and a node of the decision tree corresponds to each of logics that classify the data included in the data set from a root to each leaf of the decision tree;
specifying a branch to be pruned of the decision tree in accordance with variation in the data belonging to each leaf of the created decision tree;
recreating the decision tree in accordance with the data set corresponding to the decision tree in which the specified branch has been pruned; and
outputting each of the logics corresponding to the each node of the recreated decision tree as a description result of the prediction model.

2. The method according to claim 1, wherein
the specifying of the branch is configured to:
calculate a cost of a case of pruning a branch having variation in the data belonging to the leaves of the decision tree; and
specify a branch that minimizes the calculated cost as the branch to be pruned.

3. The method according to claim 2, wherein
the specifying of the branch and the recreating of the decision tree are performed repeatedly until a difference between the cost calculated for the decision tree recreated this time and the cost calculated for the decision tree recreated previous time becomes less than a predetermined value.

4. The method according to claim 1, wherein
the data set is a data set to be used for generating the prediction model to which the prediction result is given as a correct answer, and
the selecting of the plurality of models is configured to select the plurality of models on the basis of the data set and the prediction result given to the data set.

5. A non-transitory computer-readable storage medium for storing a prediction model description program which causes a processor to perform processing, the processing comprising:
selecting a plurality of models in accordance with data set and a prediction result of a prediction model for the data set, each of the plurality of models being configured to linearly separate data included in the data set input to the prediction model;
creating a decision tree such that a leaf of the decision tree corresponds to each of the plurality of selected models and a node of the decision tree corresponds to each of logics that classify the data included in the data set from a root to each leaf of the decision tree;
specifying a branch to be pruned of the decision tree in accordance with variation in the data belonging to each leaf of the created decision tree;
recreating the decision tree in accordance with the data set corresponding to the decision tree in which the specified branch has been pruned; and
outputting each of the logics corresponding to the each node of the recreated decision tree as a description result of the prediction model.

6. The non-transitory computer-readable storage medium according to claim 5, wherein
the specifying of the branch is configured to:
calculate a cost of a case of pruning a branch having variation in the data belonging to the leaves of the decision tree; and
specify a branch that minimizes the calculated cost as the branch to be pruned.

7. The non-transitory computer-readable storage medium according to claim 6, wherein
the specifying of the branch and the recreating of the decision tree are performed repeatedly until a difference between the cost calculated for the decision tree recreated this time and the cost calculated for the decision tree recreated previous time becomes less than a predetermined value.

8. The non-transitory computer-readable storage medium according to claim 5, wherein
the data set is a data set to be used for generating the prediction model to which the prediction result is given as a correct answer, and
the selecting of the plurality of models is configured to select the plurality of models on the basis of the data set and the prediction result given to the data set.

9. A prediction model description device comprising:
a memory; and
a processor coupled to the memory, the processor being configured to:
select a plurality of models in accordance with data set and a prediction result of a prediction model for the data set, each of the plurality of models being configured to linearly separate data included in the data set input to the prediction model;
create a decision tree such that a leaf of the decision tree corresponds to each of the plurality of selected models and a node of the decision tree corresponds to each of logics that classify the data included in the data set from a root to each leaf of the decision tree;
specify a branch to be pruned of the decision tree in accordance with variation in the data belonging to each leaf of the created decision tree;
recreate the decision tree in accordance with the data set corresponding to the decision tree in which the specified branch has been pruned; and
output each of the logics corresponding to the each node of the recreated decision tree as a description result of the prediction model.

10. The prediction model description device according to claim 9, wherein
the specifying of the branch is configured to:
calculate a cost of a case of pruning a branch having variation in the data belonging to the leaves of the decision tree; and
specify a branch that minimizes the calculated cost as the branch to be pruned.

11. The prediction model description device according to claim 10, wherein
the specifying of the branch and the recreating of the decision tree are performed repeatedly until a difference between the cost calculated for the decision tree recreated this time and the cost calculated for the decision tree recreated previous time becomes less than a predetermined value.

12. The prediction model description device according to claim 9, wherein
the data set is a data set to be used for generating the prediction model to which the prediction result is given as a correct answer, and
the selecting of the plurality of models is configured to select the plurality of models on the basis of the data set and the prediction result given to the data set.
